(19) United States
(12) Patent Application Publication
(10) Pub. No.: US 2017/0334154 A1
(43) Pub. Date: Nov. 23, 2017

(54) Laminated Moulded Parts and Manufacture Thereof

(71) Applicant: Gurit (UK) Limited, Newport, Isle of Wight (GB)

(72) Inventors: Daniel Thomas Jones, Cowes, Isle of Wight (GB); Stephen Patrick Main, Southampton (GB); Danny Keith Watts, Binstead, Isle of Wight (GB)

(73) Assignee: Gurit (UK) Limited, Newport, Isle of Wight (GB)

(21) Appl. No.: 15/531,938

(22) PCT Filed: Nov. 30, 2015
(86) PCT No.: PCT/EP15/78019

§ 371 Date: May 31, 2017

(30) Foreign Application Priority Data
Dec. 1, 2014 (GB) 1421281.5

(51) Int. Cl. B29C 70/70; B29C 70/46; B32B 5/02; B32B 27/38; B29C 70/22; B29C 53/38; B29K 105/08; B29C 53/36; B29K 63/00; B29K 307/04; B29K 707/04

(52) U.S. Cl. CPC B29C 70/70; B29C 70/222; B29C 70/467; B32B 5/024; B32B 27/38; B29C 53/387; B29C 2053/365; B29K 2063/00; B29K 2307/04; B29K 2707/04; B32B 2262/106; B29K 2105/089

(57) ABSTRACT

A laminated moulded part of fibre-reinforced resin matrix composite material, the moulded part comprising a first ply comprising fibres impregnated with a resin, an outer surface of the first ply defining an outer surface of the laminated moulded part, a rope located around at least a part of a periphery of the first ply, the rope comprising a plurality of strands of fibres twisted together and impregnated with a resin, a second ply comprising fibres impregnated with a resin, the second ply at least partly covering an inner surface of the first ply, at least a portion of a peripheral edge of the second ply being located inwardly of a corresponding portion of the rope, and at least a portion of the periphery of the first ply being folded over so as to wrap around the rope and cover the corresponding peripheral edge of the second ply.

### FIELD OF THE INVENTION

The present invention relates to a method of moulding a moulding material to form a laminated moulded part of fibre-reinforced resin matrix composite material, and to a laminated moulded part of fibre-reinforced resin matrix composite material. In particular, the present invention relates to such a method which is for manufacturing moulded parts composed of fibre reinforced resin matrix composite materials, such as, for example, panels, more particularly automotive body panels, having a high quality surface finish.

### BACKGROUND OF THE INVENTION

It is known to produce moulded parts for various applications, and having various shapes and configurations, by moulding materials including polymer resins, in particular for the manufacture of moulded parts composed of fibre reinforced resin matrix composite materials. Such composite materials are typically manufactured from moulding materials which may typically comprise, for example, (a) the combination of dry fibres and liquid resin, (b) prepregs and/or (c) sheet moulding compounds (SMC). Other materials may also be present, such as sandwich core materials and surfacing layers for forming a desired surface finish on the moulded part.

Many products are moulded by a manual process of laying-up the moulding material into a one sided mould, which moulds a single side of the resultant moulded article. Other products require a two-sided moulding process. In order to provide high manufacturing tolerance to the two-sided moulded part, it is sometimes required to use a press-moulding process in which the moulding material is moulded in a closed mould under elevated pressure.

A particular problem encountered with press moulding of an initial charge, or preform, of moulding material which at least partially comprises prepreg and/or SMC components, is that due to manufacturing tolerances in the initial charge the volume of the mould cavity is not always equal to the volume of the initial charge. Consequently, it is difficult to control the moulding process, especially to produce a composite material part having a moulded shape and dimensions which, on exit from the mould, have very close tolerance to the desired final shape and dimensions of the ultimately manufactured part, i.e. a “net shape moulded part”.

This problem is particularly acute when the moulded part has fine edge details, not only because fine shape and dimensions need to be accurately moulded but also because exposed edges of the composite material must be sealed with resin, so that the fibres are not exposed, in order to avoid cosmetic or structural defects occurring during subsequent manufacturing steps or during use of the moulded part.

Currently, using known composite material moulding technology, it is difficult to produce a press-moulded net shape moulded part from a composite material which does not require to be machined, trimmed or re-worked after moulding.

Autoclave processing has historically been used to produce composite material parts having a high quality “cosmetic” surface finish. Autoclave processing has been used for the manufacture of these parts, in preference to vacuum bag curing, because the higher autoclave pressure during resin impregnation and curing reduces the tendency for resin voids and pin-hole defects in the surface, resulting in a poor finish in the final lacquer coated components. VARTM/RTM type processes are less preferred due to the tendency to distort fabrics during lay-up and the resin injection disturbing and distorting the woven finish.

It is accordingly an aim of this invention to provide a method of press moulding which at least partially overcome at least some of these significant disadvantages of the known press moulding materials and methods currently used to manufacture moulded parts of fibre reinforced resin matrix composite material, in particular which manufacture such parts using prepregs.

### SUMMARY OF THE INVENTION

The present invention provides a method of moulding a moulding material to form a laminated moulded part of fibre-reinforced resin matrix composite material, the method comprising the steps of:

i. disposing a first ply of a prepreg material on a mould, the first ply of prepreg material comprising fibres at least partially impregnated with a resin;
ii. disposing a rope around at least a part of a periphery of the first ply, the rope being located inwardly of a peripheral edge of the first ply, the rope comprising a plurality of strands of fibres twisted together;
iii. before or after step ii, disposing a second ply of a prepreg material on the first ply, the second ply of prepreg material comprising fibres at least partially impregnated with a resin, at least a portion of a peripheral edge of the second ply being located inwardly of a corresponding portion of the peripheral edge of the first ply, steps ii and iii providing an assembly in which the peripheral edge of the second ply is located inwardly of the rope;
iv. folding over at least a portion of the periphery of the first ply so as to wrap around the rope and cover the corresponding peripheral edge of the second ply;
v. disposing the resultant moulding material in a mould tool;
vi. closing the mould tool to define a closed mould cavity containing the moulding material; and
vii. applying pressure to the mould cavity to cause resin to flow and impregnate the fibres and to configure the moulding material in a fully moulded shape to form a laminated moulded part from the moulding material.

The present invention further provides a laminated moulded part of fibre-reinforced resin matrix composite material, the moulded part comprising a first ply comprising fibres impregnated with a resin, an outer surface of the first ply defining an outer surface of the laminated moulded part, a rope located around at least a part of a periphery of the first ply, the rope comprising a plurality of strands of fibres twisted together and impregnated with a resin, a second ply comprising fibres impregnated with a resin, the second ply at least partly covering an inner surface of the first ply, at least a portion of a peripheral edge of the second ply being located inwardly of a corresponding portion of the rope, and at least a portion of the periphery of the first ply being folded over so as to wrap around the rope and cover the corresponding peripheral edge of the second ply.

Accordingly, the present invention provides a method which is particularly suitable for manufacturing parts composed of fibre reinforced resin matrix composite materials, such as, for example, panels, more particularly automotive body panels which are fully impregnated and require no or limited subsequent trimming, machining or rework operations.

In particular, the preferred embodiments of the present invention can manufacture a moulded part which can exhibit a high quality aesthetic finish in which the fibres, in particular carbon fibres, are visible in the final moulded surface, for example what is referred to herein as a “cosmetic carbon” moulded product. Some applications, for example in the automotive industry, require the carbon fabric to be visible in the final product to emphasise the high technology nature of the product. It is important that the cosmetic carbon product has a high quality surface finish on all surfaces, including edges, which are visible in use.

The preferred embodiments of the present invention can provide the assembly of a net shaped preform in a mould, and then the preform is transferred to a press mould for press moulding. The use of press moulding allows a faster cure for the thermosetting resin than conventional autoclave processing which is used for the manufacture of composite material parts having a high quality surface finish as the press can be kept hot at the required cure temperature whereas in autoclave processing the tool is cycled between a relatively cool lay-up and a relatively hot cure temperature.

The preferred embodiments of the present invention can provide a net shaped preform which, after press moulding, exhibits in the final moulded part a high quality A surface, and also a high quality B surface. The moulded part has a smoothly rounded, beaded edge that just needs de-flashing (rather than machining) before coating with a clear lacquer finish coat.

The preferred embodiments of the present invention can enable the use of simple press mould tooling with a bulb feature to give a beaded edge feature without the need to have sliding tool parts to de-mould the component. This gives the advantage of a sealed and cosmetic pleasing edge which is safe to handle, and has enhanced stiffness and strength. The sealed moulded edge reduces moisture ingress into the laminate as compared to a machined edge, and that sealing can reduce the risk of delaminating the lacquer coating applied to the moulded part to finish the component.

The provision of a net-shaped preform with a beaded edge which is then press moulded improves the surface properties, particularly at the “A-surface” which is, in use, the front face of the moulded part.

The press moulding method of the invention may be employed to produce high volume, lightweight, low cost automotive body panels composed of composite material, and such production may incur minimal labour costs as a result of reducing or avoiding post-moulding finishing costs since the resin flash is minimised or eliminated and the part is accurately moulded.

The resin composition may be selected to have a high degree of cross-linking, so as to have a high glass transition temperature Tg, with the result that the moulded part is able to be conveyed along a high temperature paint line without distortion or surface damage to maintain what is categorised for automotive body panels by those skilled in the art as a “class A” surface finish.

### BRIEF DESCRIPTION OF THE DRAWINGS

Embodiments of the present invention will now be described by way of example only, with reference to the accompanying drawings, in which:

FIGS. 1a-1f schematically illustrate a cross section through a part of a moulding material for use in a press moulding method in accordance with a first embodiment of the present invention, there being shown a sequence of steps in a moulding material assembly process;

FIG. 2 schematically illustrates a perspective view of the assembly of layers in the moulding material of FIG. 1f;

FIG. 3 is an enlargement of part of FIG. 2 (labeled Section A);

FIG. 4 schematically illustrates a cross section of an edge of a press moulding tool for press moulding the moulding material in accordance with the first embodiment of the present invention;

FIGS. 5a-5b are micrographs showing a cross section through the edge of a press moulded part produced in accordance with an Example of the present invention; and

FIGS. 6a-6c are micrographs showing a cross section through the edge of a press moulded part produced in accordance with a Comparative Example not in accordance with the present invention.

### DETAILED DESCRIPTION

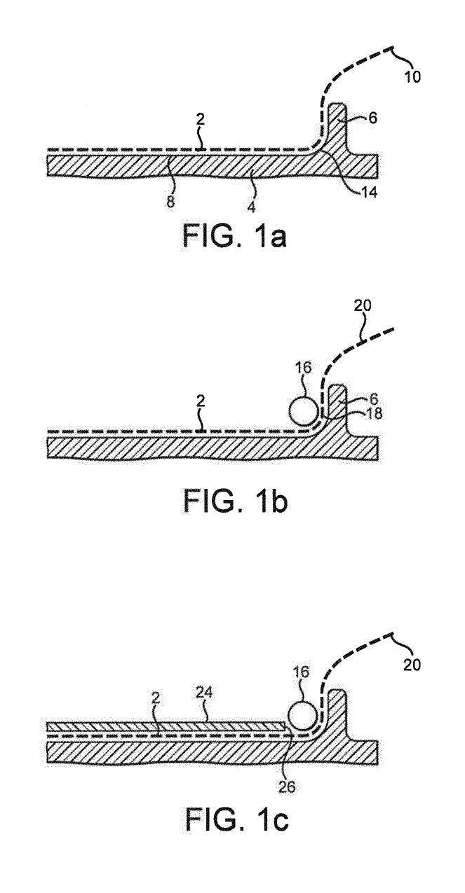

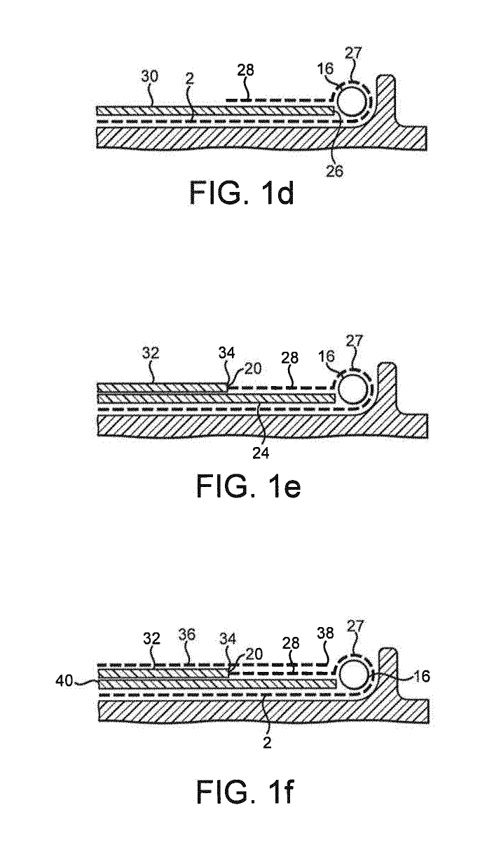

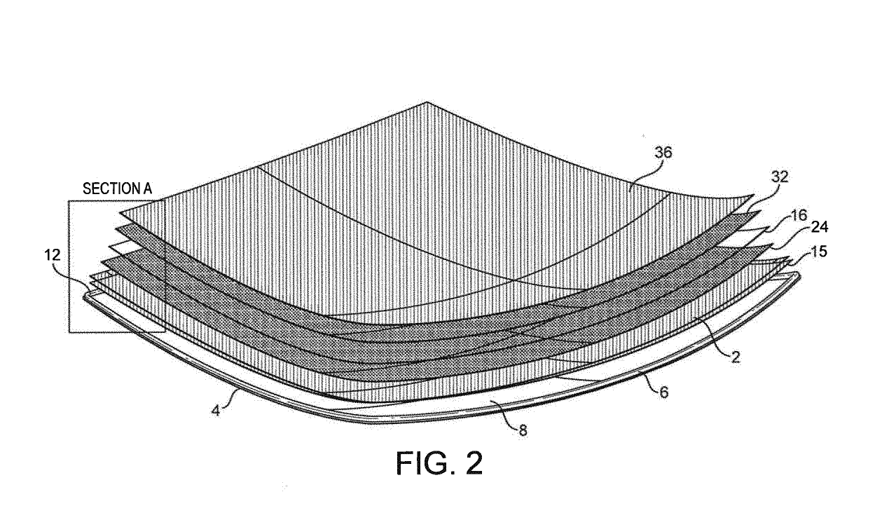

Referring to FIGS. 1a-1f, 2, and 3 there is shown in schematic form a method of moulding a moulding material to form a laminated moulded part of fibre-reinforced resin matrix composite material in accordance with an embodiment of the present invention.

In a first step, shown in FIG. 1a and FIGS. 2 and 3, a first ply 2 of a prepreg material is disposed on a mould 4. The mould 4 has a raised peripheral rim 6 surrounding a moulding surface 8. The moulding surface 8 has a three-dimensional shape and the first ply 2 is draped onto the moulding surface 8 to assume the three-dimensional shape. Typically, the moulding surface 8 defines a panel shape and the moulded part is in the form of a laminated panel, optionally an automotive body panel. The moulding surface 8 is configured to define the “A-surface” which is, in use, the front face of the resultant moulded part. In the illustrated embodiment the panel has a substantially rectangular plan, but any regular, e.g. polygonal, or irregularly shaped moulded parts may be manufactured according to various different embodiments of the present invention.

As described hereinafter, the rim 6 is utilised to manufacture a laminated moulded part in which at least a portion of, optionally the entire, peripheral edge of the laminated moulded part is formed from the folded-over first ply to form a smoothly curved folded edge of the moulded part. A rope and folded-over first ply form a reinforced bead at the peripheral edge of the laminated moulded part. In the illustrated embodiment the rim 6 is provided around the entire moulding surface 8 to form a reinforced bead at the peripheral edge of the entire laminated moulded part. However, in other embodiments the reinforced bead surrounds only part of the laminated moulded part.

The first ply 2 of prepreg material comprises fibres at least partially impregnated with a resin. The first ply 2 typically comprises a carbon fibre woven fabric fully impregnated with thermosetting resin, typically an epoxy resin. The fabric is selected to provide low distortion of the fibres during manufacture so that in the final moulded surface there is a high quality aesthetic finish provided by the fibres of the fabric, particularly when the moulded A-surface comprises carbon fibres.

The first ply 2 extends outwardly over and/or above the peripheral rim 6 to define an extending portion 10 of the first ply 2. As will be described hereinafter, the extending portion 10 is folded back later during the manufacturing process. Consequently, if the peripheral rim 6 has a corner 12 then the first ply 2 may be provided with one or more cuts or cut-outs 15 at the corner 12 to enable the folding back to be achieved with reduced, minimum or no overlap of the folded-back parts of the first ply 2 in the vicinity of the corner 12.

The first ply 2 is pushed into contact with the lower end 14 of the rim 6, particularly in any corners 12 of the rim 6.

Thereafter, as shown in FIG. 1b and FIGS. 2 and 3, a rope 16 is disposed around at least a part of a periphery 18 of the first ply 2. The rope 16 is located inwardly of a peripheral edge 20 of the first ply 2, and within the peripheral rim 6. The rope 16 is pushed into the first ply 2 and towards the rim 6, particularly in any corners 12 of the rim 6. In the illustrated embodiment the rope 16 extends around the entire periphery 18 of the first ply 2 and the opposite ends 20 of the rope 16 are butted together.

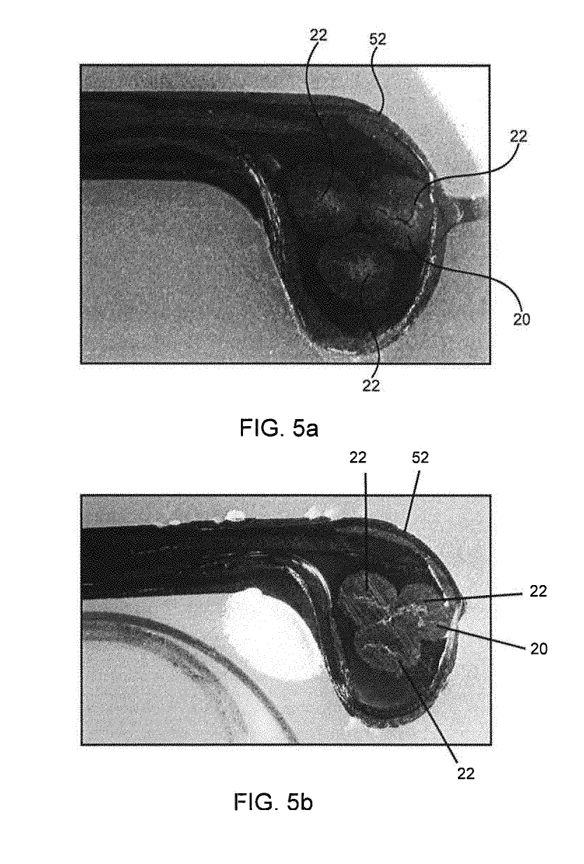

The rope 16 comprises a plurality of strands 22 of fibres twisted together, as shown in FIG. 5. The material of the fibres of the rope 16 typically has a tensile modulus of at least 2 GPa, preferably greater than 50 GPa. Also, preferably the material of the fibres of the rope 16 is selected to have a shrinkage of no more than 1% during the moulding step, as described below. The rope is selected to have a coefficient of thermal expansion and modulus substantially the same as, for example within +/−10% of, the corresponding parameters for the fibrous reinforcement plies. Typically, the fibres of the rope 16 comprise carbon fibres, although other high modulus, low thermal shrinkage fibres may be employed, such as glass fibres or heat set polymer, for example polyester, fibres.

The rope 16 comprises at least three strands 22 of fibres twisted together. The rope 16 may be a twisted rope or in the form of a cord. In the illustrated embodiment a three strand carbon fibre rope 16 is employed. The rope 16 has a substantially circular cross-section, and each strand 22 of the rope 16 has a substantially circular cross-section. This provides that the cross-section of the rope 16 is substantially isotropic, so that rotation of the rope 16 does not substantially vary the thickness of the rope 16 in any given cross-section. Typically, each strand 22 of the rope 16 is individually twisted, and the strands 22 are twisted together to form the rope 16. The manufacture of a twisted rope 16 from individually twisted strands 22 is well-known in rope-making.

The rope 16 allows a consistent geometry of the rolled, folded-over edge to be formed and draped to follow the corners 12 of the mould 4 and the laminator can feel that the rope 16 is correctly pushed into the preform mould corners 12.

As shown in FIG. 1c and FIGS. 2 and 3, a second ply 24 of a prepreg material is disposed on the first ply 2. The second ply 24 of prepreg material comprises fibres at least partially impregnated with a resin. As for the first ply 2, in this embodiment the second ply 24 may be composed of a carbon fibre woven fabric impregnated with an epoxy resin.

The peripheral edge 26 of the second ply 24 is located inwardly of the peripheral edge 20 of the first ply 2 and inwardly of the rope 16.

In a modified method, the second ply 24 is disposed on the first ply 2 before the rope 16 is disposed on the first ply 2. Furthermore, in alternative embodiments more than one second ply may be employed in a stacked configuration.

Then, as shown in FIG. 1d, the extending portion 10 of the periphery 18 of the first ply is folded over so as to wrap around the rope 16 and cover the peripheral edge 26 of the second ply 24. This forms a substantially rounded rolled portion 27 surrounding the rope 16 and a substantially flat folded-over portion 28 which is inward of the rope 16. Typically, the first ply 2 is folded over so that the folded-over portion 28 has a width of from 5 to 50 mm, optionally from 10 to 30 mm, further optionally from 15 to 25 mm, for example 20 mm. The folded-over portion 28 is preferably tacked to an upper surface 30 of the second ply 24. The width of the folded-over portion 28 is selected to ensure that it tacks down; a too short distance may not tack down but tends to lifts and a too long distance tends to be harder to fold back without distorting. The cut peripheral edge 20 of the first ply 2, which is the visible ply in use at the front surface and the peripheral edge of the resultant moulded part, is accordingly remote from the split line of the subsequently used press moulding tool, otherwise it is possible that the fibres of the first ply 2 may tend to migrate and distort during press moulding.

The folded-over portion 28 is tacked to the upper surface 30 of the second ply 24 by the inherent tack of at least one or both of the first ply 2 and the second ply 24. Alternatively, the folded-over portion 28 may be tacked to the upper surface 30 of the second ply 24 by a tackifier applied to at least one of the first ply 2 and the second ply 24. Preferably some heat and a roller pressure is used to consolidate the rolled, folded-over edge and ensure that the rope 16 is correctly placed.

Thereafter, as shown in FIG. 1e and FIGS. 2 and 3, a third ply 32 of a prepreg material is disposed on the second ply 24. The third ply 32 of prepreg material comprises fibres at least partially impregnated with a resin. As for the first and second plies, in this embodiment the third ply 32 may be composed of a carbon fibre woven fabric impregnated with an epoxy resin. The peripheral edge 34 of the third ply 32 is located inwardly of, and abuts against, the peripheral edge 20 of the folded-over part 28 of the first ply 2. An abutting of the plies is employed so as preferably to avoid an overlap which can cause a local increase in fibre thickness which can prevent the press moulding tool from shutting. Also, gaps between the abutting plies of greater than >2 mm are preferably avoided otherwise the gap can result in a visible witness mark which can be seen through to the surface of thin carbon fibre panels.

Finally in the assembly process, shown in FIG. 1f and FIGS. 2 and 3, a fourth ply 36 of a prepreg material is disposed on the third ply 32 and the folded-over part 28. The fourth ply 36 of prepreg material comprises fibres at least partially impregnated with a resin. As for the first, second and third plies, in this embodiment the fourth ply 36 may be composed of a carbon fibre woven fabric impregnated with an epoxy resin. This provides an assembly in which the fourth ply 36 covers the abutting peripheral edges 20, 34 of the first and third plies 2, 32. Typically, the peripheral edge 38 of the fourth ply 36 is located inwardly of, and substantially adjacent to, the substantially rounded rolled portion 27 of the first ply 2, and is above the folded-over part 28 of the first ply 2. Optionally, jn further embodiments additional plies may be laminated over the fourth ply 36.

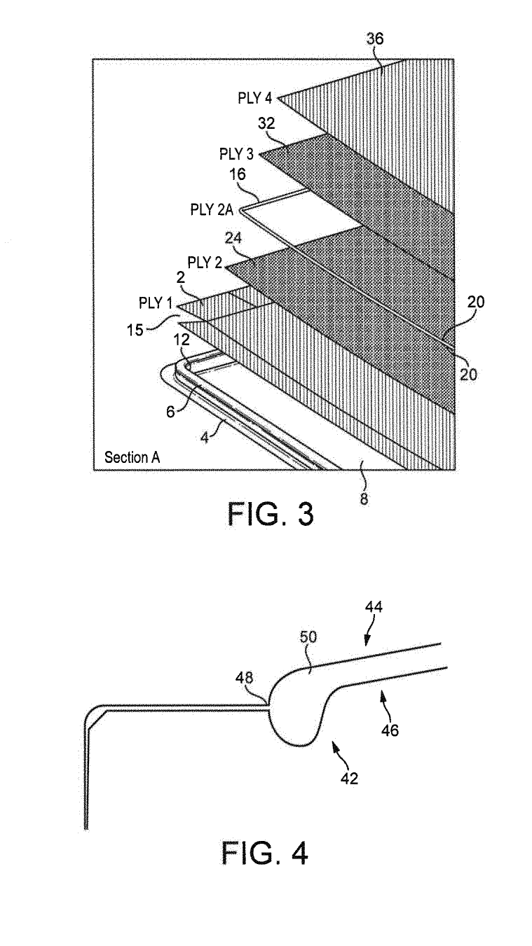

The resultant moulding material 40 is disposed in a mould tool 42, schematically shown in FIG. 4. The moulding material 40 is transferred from the mould 4 used to assemble the moulding material 40 to a separate mould tool 42 having upper and lower mould halves 44, 46, separated by a mould split line 48. The mould tool 42 is then closed to define a closed mould cavity 50 containing the moulding material 40. In a pressing step a moulding pressure, at elevated temperature, is applied to the mould cavity 50 to consolidate the moulding material 40 and to cause the resin to flow and impregnate the fibres, including the fibres in the rope 16, and to configure the moulding material 40 in the final moulded shape. Typically, the moulding step is carried out at an elevated temperature of at least 50° C. The selected temperature is dependent upon the selection of the specific curing temperature of the thermosetting resin.

This press moulding operation forms a laminated moulded part 52, as shown in FIGS. 5a-5b, from the moulding material 40.

The moulding material 40 produced on the mould 4 and disposed in the mould tool 42 has the same dimensions, shape and configuration as the final laminated moulded part 52. Consequently, the press moulding operation ensures full resin impregnation of the fibres and avoidance of voids in the resin, and also cures the thermosetting resin, but does not substantially modify the dimensions, shape and configuration of the moulding material when forming the final laminated moulded part. Therefore the moulding material is a “near net shape” preform. During press moulding there is minimum resin flash formed at the junction of the press mould tool halves. Whatever minimum resin flash is formed can readily be removed by snapping, cutting or sanding. Since the moulding material has substantially the final desired dimensions, shape and configuration as the final laminated moulded part, these dimensions, shape and configuration can readily be achieved during the prepreg layup assembly process in the assembly mould, thereby minimising post-moulding shaping or trimming of the final laminated moulded part. The bead assists rigidification of the moulding material during transfer from the mould to the press mould tool. Also, the bead provides a highly aesthetic peripheral edge to the moulded part, which is particularly important when the moulded part is a vehicle body panel mounted so that the peripheral edge is visible.

In the illustrated embodiment, the rope and the extended portion of the first ply which is folded over extends around the entire periphery of the moulding material. This forms a peripheral bead around the entire moulded part. However, in modified embodiments the peripheral bead may be formed around only one or more selected peripheral portions of the moulded part, and correspondingly the rope, the prepreg plies and the mould are correspondingly dimensioned.

The resultant laminated moulded part of fibre-reinforced resin matrix composite material comprises the first ply 2 comprising fibres impregnated with a resin. The outer surface of the first ply 2 defines an outer surface of the laminated moulded part. The rope 16 is located around at least a part of a periphery of the first ply 2. The rope 16 comprises a plurality of strands of fibres twisted together and impregnated with a resin. The second ply 24 comprises fibres impregnated with a resin. The second ply 24 at least partly covers an inner surface of the first ply 2. At least a portion of a peripheral edge of the second ply 24 is located inwardly of a corresponding portion of the rope 16. At least a portion of the periphery of the first ply 2 is folded over so as to wrap around the rope 16 and cover the corresponding peripheral edge of the second ply 24. The third ply 32 comprises fibres impregnated with a resin, and at least a portion of a peripheral edge of the third ply 32 is located inwardly of, and abuts against, a corresponding portion of the peripheral edge of a folded-over part of the first ply. The fourth ply 36 comprises fibres impregnated with a resin, the fourth ply 36 covering the abutting edges of the first and third plies. At least a portion of a peripheral edge of the fourth ply 36 is located inwardly of, and substantially adjacent to, a corresponding portion of the substantially rounded rolled portion 27 of the first ply 2, and is above the folded-over part 28 of the first ply 2.

The outer surface of the laminated moulded part is three-dimensionally shaped. At least a portion of, optionally the entire, peripheral edge of the laminated moulded part is formed from the folded-over first ply to form a smoothly curved rolled edge of the moulded part. The rope and the folded-over first ply form a reinforced bead at the peripheral edge of the laminated moulded part. As described above, typically the rope and the portion of the first ply which is folded over extend around the entire periphery of the laminated moulded part. The laminated moulded part is typically panel shaped, or example being an automotive body panel.

In the preferred embodiments of the present invention, carbon fibre prepreg material is employed as the first, second, third and fourth plies. However, in other embodiments other fibres may be employed, such as glass fibres. Furthermore, one or more additional plies may be provided in the assembly, either locally or throughout the entire moulded part. The resultant multilayer laminate is an engineered structure which is configured to achieve low weight and to avoid thermal warping as cools down from the moulding temperature. In some areas of the multilayer laminate optional additional reinforcements may be provided for localised strength. The fibre layers are selected to provide the desired mechanical properties to the resultant moulded part. For example, when the moulded part is intended to be an automotive body panel, the fibre layers have a low coefficient of thermal expansion and high tensile modulus.

The resin used in the moulding material is typically a curable thermosetting resin, such as an epoxy resin. The resin is preferably selected to have a composition to provide, when cured, a high glass transition temperature Tg, for example a Tg of at least 120° C., more preferably 150° C., or 200° C. This high temperature is selected so that the cured moulded part can be subjected to elevated temperatures, for example by passing a press moulded automotive body panel down a high temperature automotive body paint line, without degradation or warping of the panel.

A thermosetting resin, such as an epoxy resin, which is thermally stable at 200° C. has a high cross link density, and correspondingly tends to exhibit a highly exothermic cure. Accordingly, the structure of the panel is adapted to resist degradation or warping of the part during the exothermic cure.

The resultant fibre/resin structure provides panel stiffness and the entire multilayer structure tends not to warp during manufacture or use. The carbon fibre exhibits a low coefficient of thermal expansion and a high tensile modulus, such as Young's modulus.

During cure, the relative layer positions are readily maintained to retain the mechanical properties of the engineered structure and avoid warping.

During the moulding operation, the mould tool is closed to define the mould cavity. The temperature and pressure are increased to consolidate the moulding material and cause the resin to flow throughout the entire mould cavity and fully impregnate the fibrous material of the moulding material. During the moulding process the hydraulic pressure of the resin increases during the consolidation and impregnation steps to ensure resin flow throughout the entire mould cavity, and ensure full and consistent resin impregnation.

After the press moulding operation has terminated and the resin has fully cured, the mould tool is opened, and the moulded part is demoulded from the mould tool.

The present invention is further illustrated with reference to the following non-limiting Examples.

### Example 1

A cosmetic woven carbon component 1.2 m wide×1.1 m long with a nominal wall thickness of 1.27 mm was made by press moulding in a fixed cavity tool set Gurit SE160 and Gurit ST160 prepregs and a rope formed by winding three 24K dry carbon ends cut from a standard bobbin.

The first, second third and fourth plies, and the top, had the following properties as summarised in Table 1.

TABLE 1

| Ply | Product | Product Description | |
|---|---|---|---|
| 1 | PA13- | SE160/RC245T/1250/ | 245 gsm 3K Carbon 2 × 2 |
| | 6210 | 42%/POPA | Twill 0/90 woven 160 Tg |
| | | | Epoxy prepreg with 42% |
| | | | resin content |
| 2 | SA23- | ST160/XC300C/1270/ | 300 gsm 12K Carbon Non |
| | 6436 | 51%/S/S | Crimp stitiched Biaxial |
| | | POPA | Carbon 160 Tg Epoxy |
| | | | prepreg with 42% resin |
| | | | content |
| 2a | | Three 24K Carbon ends cut from a bobbin were | |
| Rope | | wound to form a rope by twisting the yarn opposite | |
| Insert | | to that of the strand to form a stable rope | |
| 3 | SA23- | ST160/XC300C/1270/ | 300 gsm 12K Carbon Non |
| | 6436 | 51%/S/S | Crimp stitiched Biaxial |
| | | POPA | Carbon 160 Tg Epoxy |
| | | | prepreg with 42% resin |
| | | | content |
| 4 | PA13- | SE160/RC245T/1250/ | 245 gsm 3K Carbon 2 × 2 |
| | 6210 | 42%/POPA | Twill 0/90 woven 160 Tg |
| | | | Epoxy prepreg |

Referring to FIGS. 1a-1f, and 2 to 4, an oversized Ply 1 was laid up onto a preform mould duplicating the geometry of the final press mould. Ply 1 was draped and consolidated into the corners using a plastic “dibber” tool to ensure the prepreg was formed into the mould perimeter. The 4 corners of the part were cut so they could be later folded back on themselves. A rope was added and worked into the corners. It was cut and butt jointed on one side. Ply 2 was draped into the mould which was finished 2 mm from the mould corner. Ply 1 was then tightly wrapped over the rope to extend past the rope by 20 mm and tacked to Ply 2. Ply 3 was then fitted and cut to butt joint to Ply 1. Ply 4 was sized to finish next to the inside edge of the wrapped around rope. A 40 mm wide roller and heat gun was used to locally heat and consolidate the preform to give a pronounced rolled edge and ensure the rope was located into the corner detail.

The completed preform was cooled and demoulded from the preform tool. The preform was then transferred into a hot press mould and subjected to a vacuum as the press closed before applying 1500 KN closing pressure and curing for 15 min at a temperature of 150° C. before demoulding. The finished part was free of defects with fibre present within all the bead around the part perimeter and giving a high quality cosmetic carbon finish all over the part A surface including the beaded edge.

The panel had a thickness of about 1 to 2 mm. The bead had a height of about 4 mm. The lower end of the bead had a radius of about 1 mm.

Two micrograph cross-sections through an edge of the moulded part are shown in FIGS. 5a and 5b. A consistently shaped and moulded bead was formed around the periphery of the moulded panel, with no resin voids. There was minimal flash at the mould tool split line which could readily be removed by snapping the resin flash and light abrasion to form a finished aesthetically acceptable moulded part with a rolled, hemmed and beaded edge.

### Example 2

The same components, preform mould and cure process were used as in Example 1 except that the carbon rope was replaced by a 3 mm diameter Vectran rope available for dingy and yachting rigging. Vectran is an aromatic polyester fibre available in commerce from Kuraray Co., Ltd. The rope was heat set for 30 min at 150° C. before use in order to increase its thermal stability. On demould a high visual quality was obtained in the majority of the part with a very minor aesthetic surface defect, still meeting the quality requirement, evident from approximately 2 mm of rope shrinkage.

### Comparative Example 1

The same components, preform mould and cure process as in Example 1 were used but with the carbon rope replaced by 3 individual tows of 24 K carbon filaments not wound into a rope format. The same laminating method was used but the individual dry fibre strands were used instead of the wound rope. It was difficult to maintain the strands in the preform corners and during laminating there was lack of positive solid filaments to wrap ply 1 back in a consistant manner. On demould the press tool had not shut correctly with some laminate trapped outside the tool perimeter.

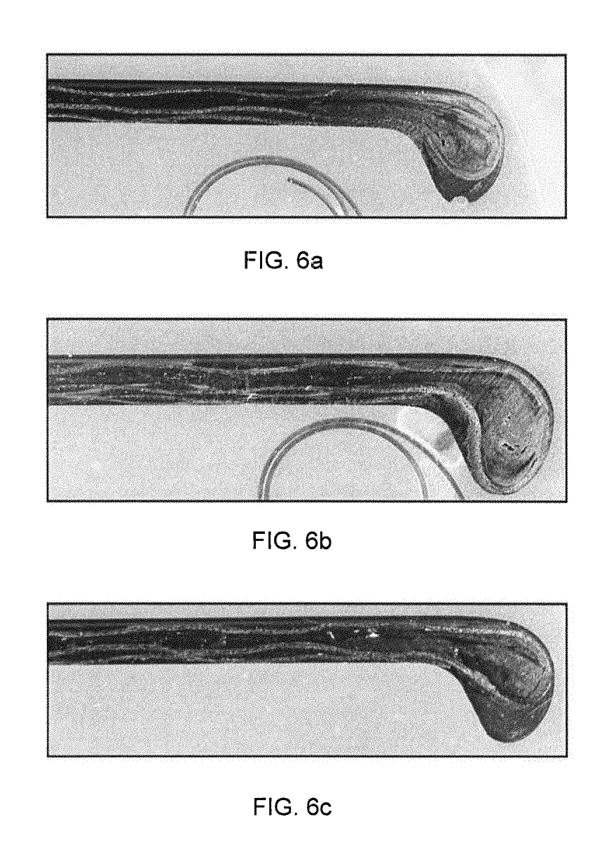

Various micrograph cross-sections through an edge of the moulded part is shown in FIGS. 6a-6c. The distorted bead can be seen, as well as resin voids.

### Comparative Example 2

The same components, preform mould and cure process were used as in Example 1 but with the carbon rope replaced by 3×24 K filaments impregnated with SE160 resin not wound into a rope format. These were tacked together to attempt to retain the filaments in the corner of the perform mould. On demould the press tool had not shut correctly and fibre was not present all inside the hemmed edge giving visual defects around the part.

A comparison of the Examples and Comparative Examples show that the rope provides a consistent shaped peripheral edge whereas in contrast non-rope filaments, such as strips of UD prepreg, towpreg dry tow, and dry fibres which are ribbon like, do not provide a consistently rounded rope to assist the laminator to consistently roll Ply 1 over the peripheral filaments to form a substantially rounded rolled peripheral edge. Ribbons tend to “flip flop” especially around corners and a consistent shape and volume of fibre in the bulb is not formed.

The preferred embodiments of the present invention can provide the press moulding of a multilayer moulding material which can deliver consistent press moulded composite parts at high material and manufacturing tolerances. This moulding material can enable net shape parts to be manufactured, thereby requiring less finishing work and permitting the use of simpler press and tooling designs.

The preferred embodiments of the present invention can provide the press moulding of a multilayer which enables a net shape moulding to be made with minimal resin flash issues during the press moulding process.

Various modifications to the illustrated embodiments of the invention will be readily apparent to those skilled in the art.

1. A method of moulding a moulding material to form a laminated moulded part of fibre-reinforced resin matrix composite material, the method comprising the steps of:
i. disposing a first ply of a prepreg material on a mould, the first ply of prepreg material comprising fibres at least partially impregnated with a resin;
ii. disposing a rope around at least a part of a periphery of the first ply, the rope being located inwardly of a peripheral edge of the first ply, the rope comprising a plurality of strands of fibres twisted together;
iii. before or after step ii, disposing a second ply of a prepreg material on the first ply, the second ply of prepreg material comprising fibres at least partially impregnated with a resin, at least a portion of a peripheral edge of the second ply being located inwardly of a corresponding portion of the peripheral edge of the first ply, steps ii and iii providing an assembly in which the peripheral edge of the second ply is located inwardly of the rope;
iv. folding over at least a portion of the periphery of the first ply to as to wrap around the rope and cover the corresponding peripheral edge of the second ply;
v. disposing the resultant moulding material in a mould tool;
vi. closing the mould tool to define a closed mould cavity containing the moulding material; and
vii. applying pressure to the mould cavity to cause resin to flow and impregnate the fibres and to configure the moulding material in a fully moulded shape to form a laminated moulded part from the moulding material.

2. A method according to claim 1 further comprising the step (a), after step iii and before step v, of disposing a third ply of a prepreg material on the second ply, the third ply of prepreg material comprising fibres at least partially impregnated with a resin, steps (a) and iv providing an assembly in which at least a portion of a peripheral edge of the third ply is located inwardly of, and abuts against, a corresponding portion of the peripheral edge of a folded-over part of the first ply.

3. A method according to claim 2 further comprising the step (b), after steps (a) and iv and before step v, of disposing a fourth ply of a prepreg material on the third ply, the fourth ply of prepreg material comprising fibres at least partially impregnated with a resin, step (b) providing an assembly in which the fourth ply covers the abutting edges of the first and third plies.

4. A method according to claim 3 wherein at least a portion of a peripheral edge of the fourth ply is located inwardly of, and substantially adjacent to, a corresponding portion of a substantially rounded rolled portion of the first ply which wraps around the rope, and is above the folded-over part of the first ply folded-over part of the first ply.

5. A method according to claim 1 wherein the rope and the portion of the first ply which is folded over extends around the entire periphery of the moulding material.

6. A method according to claim 1 wherein the fibres of the first, second, third and fourth plies comprise carbon fibres.

7. A method according to claim 1 wherein the fibres of the first, second, third and fourth plies are in the form of a fabric, optionally a woven fabric.

8. A method according to claim 1 wherein each resin comprises a thermosetting resin, optionally an epoxy resin.

9. A method according to claim 1 wherein the fibres of the rope comprise carbon fibres.

10. A method according to claim 1 wherein the rope comprises at least three strands of fibres twisted together.

11. A method according to claim 1 wherein the rope has a substantially circular cross-section.

12. A method according to claim 1 wherein each strand of the rope has a substantially circular cross-section.

13. A method according to claim 1 wherein the material of the fibres of the rope has a tensile modulus of at least 2 GPa, optionally greater than 50 GPa.

14. A method according to claim 1 wherein the material of the fibres of the rope is selected to have a shrinkage of no more than 1% during the moulding step vii.

15. A method according to claim 1 wherein the mould has a raised peripheral rim surrounding a moulding surface and in step i the first ply extends outwardly over the peripheral rim, in step ii the rope is disposed within the peripheral rim and in step iv the first ply is folded over so that a peripheral edge of the substantially rounded rolled portion is adjacent the peripheral rim.

16. A method according to claim 15 wherein the moulding surface has a three-dimensional shape and in step i the first ply is draped onto the moulding surface to assume the three-dimensional shape.

17. A method according to claim 16 wherein the moulding surface defines a panel shape and the moulded part is in the form of a laminated panel, optionally an automotive body panel.

18. A method according to claim 1 wherein moulding step vii is carried out at an elevated temperature of at least 50° C.

19. A method according to claim 1 wherein in step iv the first ply is folded over so that a folded-over portion has a width of from 5 to 50 mm, optionally from 10 to 30 mm, further optionally from 15 to 25 mm.

20. A method according to claim 1 wherein the folded-over portion is tacked to an upper surface at least one of the first ply and the second ply by the inherent tack of at least one or both of the first ply and the second ply or by a tackifier applied to at least one of the first ply and the second ply.

21. (canceled)

22. (canceled)

23. A method according to claim 1 wherein in step v the moulding material is transferred from the mould used in step i to a separate mould tool.

24. A method according to claim 1 wherein the moulding material produced on the mould and disposed in the mould tool in step v has the same dimensions, shape and configuration as the moulded part of step vii.

25. (canceled)

26. A laminated moulded part of fibre-reinforced resin matrix composite material, the moulded part comprising a first ply comprising fibres impregnated with a resin, an outer surface of the first ply defining an outer surface of the laminated moulded part, a rope located around at least a part of a periphery of the first ply, the rope comprising a plurality of strands of fibres twisted together and impregnated with a resin, a second ply comprising fibres impregnated with a resin, the second ply at least partly covering an inner surface of the first ply, at least a portion of a peripheral edge of the second ply being located inwardly of a corresponding portion of the rope, and at least a portion of the periphery of the first ply being folded over so as to wrap around the rope and cover the corresponding peripheral edge of the second ply.

27. A laminated moulded part according to claim 26 further comprising a third ply comprising fibres impregnated with a resin, at least a portion of a peripheral edge of the third ply being located inwardly of, and abutting against, a corresponding portion of the peripheral edge of a folded-over part of the first ply.

28. A laminated moulded part according to claim 27 further comprising a fourth ply comprising fibres impregnated with a resin, the fourth ply covering the abutting edges of the first and third plies.

29. A laminated moulded part according to claim 28 wherein at least a portion of a peripheral edge of the fourth ply is located inwardly of, and substantially adjacent to, a corresponding portion of a substantially rounded rolled portion of the first ply which wraps around the rope, and is above the folded-over part of the first ply.

30. A laminated moulded part according to claim 26 wherein the rope and the portion of the first ply which is folded over extends around the entire periphery of the moulded part.

31. A laminated moulded part according to claim 26 wherein the fibres of the first, second, third and fourth plies comprise carbon fibres.

32. A laminated moulded part according to claim 26 wherein the fibres of the first, second, third and fourth plies are in the form of a fabric, optionally a woven fabric.

33. A laminated moulded part according to claim 26 wherein each resin comprises a thermosetting resin, optionally an epoxy resin.

34. A laminated moulded part according to claim 26 wherein the fibres of the rope comprise carbon fibres.

35. A laminated moulded part according to claim 26 wherein the rope comprises at least three strands of fibres twisted together.

36. A laminated moulded part according to claim 26 wherein the rope has a substantially circular cross-section.

37. A laminated moulded part according to claim 26 wherein each strand of the rope has a substantially circular cross-section.

38. A laminated moulded part according to claim 26 wherein the material of the fibres of the rope has a tensile modulus of at least 2 GPa, optionally greater than 50 GPa.

39. A laminated moulded part according to claim 26 wherein the first ply is folded over so that a folded-over portion has a width of from 5 to 50 mm, optionally from 10 to 30 mm, further optionally from 15 to 25 mm.

40. A laminated moulded part according to claim 26 in which the outer surface of the laminated moulded part is three-dimensionally shaped.

41. A laminated moulded part according to claim 26 in which at least a portion of, optionally the entire, peripheral edge of the laminated moulded part is formed from the substantially rounded rolled portion of the first ply to form a smoothly curved rolled edge of the moulded part.

42. A laminated moulded part according to claim 26 in which the rope and the folded-over first ply form a reinforced bead at the peripheral edge of the laminated moulded part.

43. A laminated moulded part according to claim 26 which is panel shaped, optionally being an automotive body panel.
